(19) United States
(12) Patent Application Publication
(10) Pub. No.: US 2024/0428309 A1
(43) Pub. Date: Dec. 26, 2024

(54) MACHINE-LEARNED MODEL FOR PERSONALIZING SERVICE OPTIONS IN AN ONLINE CONCIERGE SYSTEM USING LOCATION FEATURES

(71) Applicant: Maplebear Inc. (dba Instacart), San Francisco, CA (US)

(72) Inventors: Robert Fletcher, Los Angeles, CA (US); Ramasubramanian Balasubramanian, Jersey City, NJ (US); Tilman Drerup, Palo Alto, CA (US); Sharath Rao Karikurve, Berkeley, CA (US)

(21) Appl. No.: 18/214,150

(22) Filed: Jun. 26, 2023

(51) Int. Cl. G06Q 30/0601

(52) U.S. Cl. CPC G06Q 30/0613

(57) ABSTRACT

Based on logged information about prior events, an online concierge system generates a set of location metrics that quantify properties of locations such as retailers at which items may be acquired, and residences to which the items are brought. The location metrics can be used for a variety of purposes to aid customers or other users of the online concierge system, such as providing the users with more information (e.g., likely delivery delays) or alternative options (e.g., pricing options), or emphasizing options that the location metrics indicate would be of particular value to the user. To determine whether to emphasize a particular option, the online concierge system applies a machine-learned model that predicts whether emphasizing that option would effect a positive change in user behavior, relative to not emphasizing it.

### BACKGROUND

Concierge systems, which enable assistants to provide assistance to a user with the user's errands or other personal business, are of value both to the assistants and to the users, providing the users with the ability to accomplish tasks for which they lack the time or ability, and the assistants with flexible employment opportunities.

Some concierge systems facilitate assistants performing shopping on behalf of users, or otherwise traveling to particular physical locations in order to accomplish a task. For example, some assistants purchase groceries or other items at physical stores on behalf of users. In such cases, the concierge systems may provide users with a number of different options for how the system provides service to the users, such as different service levels with different cost/benefit tradeoffs. It would be beneficial to be able to intelligently predict which options will be preferred by which users so as to provide those users with options most likely to be helpful to them.

### SUMMARY

Based on logged information about prior events, an online concierge system generates a set of location metrics that quantify properties of locations such as retailers at which items may be acquired, and residences to which the items are brought. The location metrics can be used for a variety of purposes to aid customers or other users of the online concierge system, such as providing the users with more information (e.g., likely delivery delays) or alternative options (e.g., pricing options), or emphasizing options that the location metrics indicate would be of particular value to the user. To determine whether to emphasize a particular option, the online concierge system applies a machine-learned model that predicts whether emphasizing that option would produce or increase the likelihood of a positive change in user behavior, relative to not emphasizing it.

In some embodiments, the machine-learned model is trained based on an uplift technique in which the option is emphasized to a treatment group of users and not emphasized to a control group. Location metrics associated with the treatment and control groups are obtained and used as features for training, along with the measured value of a favorability metric that quantifies the effect of whether the option was emphasized.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates sub-components of the options personalization module of FIG. 2, according to some embodiments.

FIG. 4 illustrates steps performed by the options personalization module of FIG. 2 when determining whether to emphasize a particular service option to a user, according to some embodiments.

### DETAILED DESCRIPTION

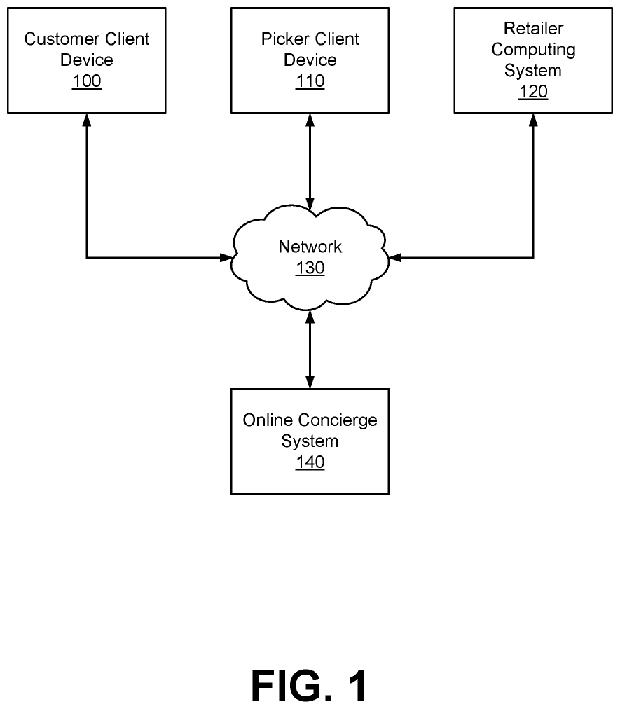

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order.

Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

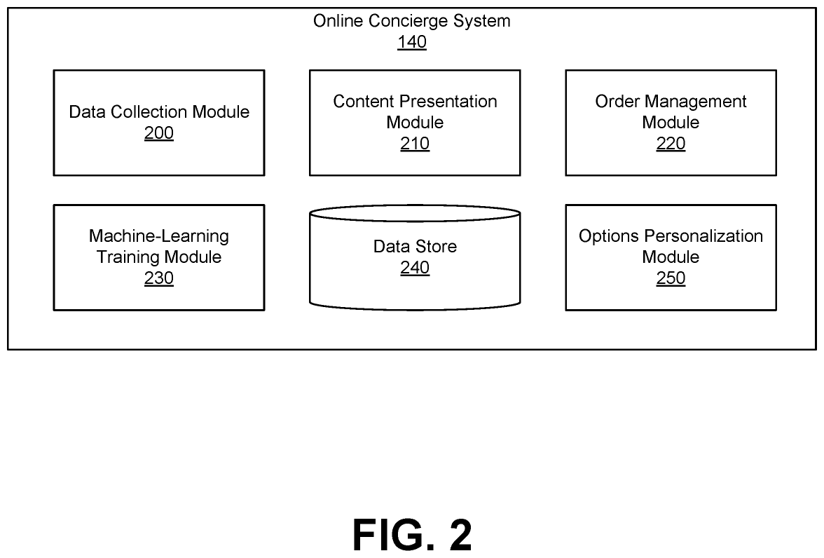

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The online concierge system 140 additionally includes an options personalization module 250 that predicts, for a given customer, which service options should be emphasized (or provided) to that customer. The options personalization module 250 uses known behavior data for users to derive location metrics that serve as features characterizing the users and their delivery requests from a retail location to a user residence location. These features may then be used in various ways to provide a better experience for customers. For example, the features can be provided as input to a machine-learned model to predict how a particular customer seeking delivery of items from a particular store or other location will behave when presented with certain service options, which enables the options personalization module 250 to determine whether/how to present the user with those service options. The components of the options personalization module 250 are now discussed in more detail.

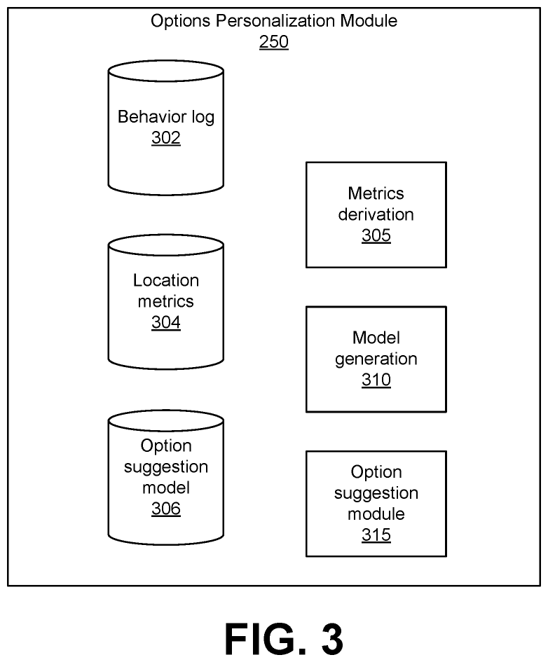

FIG. 3 illustrates sub-components of the options personalization module 250 of FIG. 2, according to some embodiments. The options personalization module 250 has, or accesses, a behavior log 302 that stores data obtained from the client devices of those users that had obtained items in the past via the online concierge system (that is, picker client devices 110, and possibly also customer client devices 110). The behavior log 302 contains entries indicating at least associated actions/events (e.g., exiting residence, arriving at residence parking, driving away from residence parking, arriving at store, beginning looking for store parking, parking at store, entering store, picking up an item, checking out of store, exiting store, leaving parking area, parking for residence, arriving at residence), as well as the time and location (e.g., a specific geocoordinate, or a more general identifier of a parking lot or store) corresponding to those actions/events. The entries may further indicate additional information, such as an identifier of a user with whom the actions/events were associated. For example, one entry might indicate that user #1830923 parked at XYZ Mart #873 at 2:32 PM on Sunday, May 28, 2023; another entry might indicate that user #7322278 entered ABC Market #43 at 10:55 AM on Monday, May 29, 2023.

The options personalization module 250 has a location metrics repository 304 that stores values for location metrics derived from that data in the behavior log 302. Such location metric values characterize the experience for particular locations, such as particular customer residences, particular retailer locations, or the relationship between a particular customer residence and a particular retailer location. The location metrics values represent an average or other form of aggregate over a set of similar variable values. For example, values for the same location (e.g., residence, or retailer) may be aggregated, and entries may be bucketed together with other entries in a similar time range (e.g., a 10-minute interval).

In some embodiments, the options personalization module 250 has a location metrics derivation module 305 that computes the location metric values in the location metrics repository 304. In some embodiments, location metrics for particular retailers include: driving time near the retailer, average time to find parking at the retailer, average time from parking to checkout at the retailer, average degree of crowdedness at the retailer, average time elapsed from parking at the retailer to entering the retailer, average time elapsed from parking at the retailer to picking a first item, and/or average time elapsed in the retailer per item. Location metrics for particular residences include: average time to find parking for the residence, average time to carry items from the residence parking to the residence, and/or normalized number of unsuccessful delivery attempts in the neighborhood containing the residence. Location metrics for retailer/residence combinations include total delivery time for deliveries from a particular retailer to locations near a particular residence.

The options personalization module 250 has, or accesses, an option suggestion model 306 that estimates how popular a particular service option will be for a given user for shopping at a particular retailer. (A “service option” is a particular manner in which use of the online concierge system 140—such as picking and delivery of items—may be accomplished for a customer, and which the customer may elect or decline. For example, standard delivery times (ETAs) within a time window are one service option; prioritized delivery times during an earlier time window are another service option; “ASAP” delivery is another service option; self-pickup by the customer is yet another service option. In some embodiments, there is a separate option suggestion model 306 for each distinct service option; in other embodiments, there is a single model covering all the service options (e.g., designed as a multi-task model that has a branch for each service option).

Rather than necessarily tracking the identities of particular users and retailers, the option suggestion model 306 uses location metrics as proxies for given users and retailers. This allows data obtained on (say) the prior shopping of a particular shopper on behalf of a particular customer to be used when assessing future purchases by other shoppers for that customer, or when the customer may choose to perform a portion of the shopping herself rather than having the items delivered.

The option suggestion model 306 takes, as input features, the location metric values for a customer's current order. (As previously noted, in some embodiments the location metrics for an order include retailer location metrics, residence location metrics, and/or retailer-residence combination metrics.) Given those input features, the option suggestion model 306 outputs a prediction of how favorable the service option in question would be for the customer's current order, as represented by a particular favorability metric. For example, in some embodiments, the prediction is a scalar value that indicates a difference in the customer's activity (as measured by the favorability metric) when the service option is emphasized to the customer, relative to when the service option is not emphasized to the customer. For instance, for a particular order of a customer, the option suggestion model 306 might indicate that emphasizing the service option in question would reduce the favorability metric in question by 20%. In some embodiments, rather than (or in addition to) determining on an order-by-order basis whether emphasizing a particular service option would be useful for a given customer, the option suggestion model 306 determines whether, for a given user (regardless of the particular order), emphasizing the particular service option is generally beneficial. In some embodiments, such determinations are made using the residence location metrics, without using the retailer location metrics. In some embodiments, the determinations also take into account other factors, such as customer price sensitivity.

The option suggestion model 306 may use different favorability metrics in different embodiments, and different models 306 in the same embodiment may use different favorability metrics. Some examples of favorability metrics used in different embodiments include N-day reordering likelihood (the probability that the user will place another order in the following N days, for some integer N), or transaction volume over the following N days (the expected number of additional orders over those N days). The favorability metric correlates with satisfaction of the user with the emphasized service option.

In some embodiments, the options personalization module 250 has a model generation module 310 that trains the option suggestion model 306 based on the location metrics 304. In some such embodiments, the model generation module 310 uses an uplift model approach, in which customer orders are partitioned into a treatment group of those in which the service option was emphasized and a control group in which the service option was not emphasized. The model generation module 310 obtains data on prior orders placed through the online concierge system 220, including the customer who placed the order, the retailer from whom the order's items were obtained, and whether the service option for which the model 306 is being trained was emphasized as part of that order. (In embodiments in which the determination is made for a given customer in general—as opposed to a particular order of the user, in particular—the model generation module 310 may only use a subset of the location features for training, such as the residence location metric features.) The location metrics for the customer's residence, the retailer location, and any customer-retailer combinations, are read from the location metrics repository 304 as features characterizing the orders, are included as features in the machine learning model. The features for an order also include an indication of whether the service option was emphasized for the order, which indicates whether the order was part of the control group. A training algorithm, such as a meta-learning algorithm, takes the features as input and generates the option suggestion model 306 as output, which in turn estimates the change in the favorability metric that is caused by the emphasis of the service option. In some embodiments, the model generation module 310 retrains the option suggestion model 306 frequently, such as at periodic intervals (e.g., weekly), as new order data are obtained, and/or as results of the option suggestion model 306 are obtained and the results arising therefrom evaluated.

The options personalization module 250 has an option suggestion module 315 that uses the option suggestion model 306 to determine how to personalize the ordering interface provided by the online concierge system 140 so as to better present service options that are appropriate for the customer in question, based on the locations involved in the customer's purchase. When a particular customer has specified an order to be carried out at a particular retailer location, the option suggestion module 315 looks up the location metrics corresponding to the customer's residence and the retailer location within the location metrics repository 304 and provides them as input features to the option suggestion model 306 corresponding to a service option of interest (e.g., the service option of prioritized delivery). The option suggestion model 306 outputs a prediction of favorability of emphasizing the service option to the customer as part of order; if the option suggestion module 315 determines that emphasizing the service option would be positive (i.e., would result in an improvement in the favorability metric, relative to not emphasizing the service option), the option suggestion module 315 emphasizes the service option to the customer. Whether emphasizing the service option would be “positive” may be determined by comparing the prediction of favorability to a threshold value, such as 0 or 1, and determining whether the prediction meets or exceeds that threshold. (The exact threshold value is determined by the training algorithm itself, which produces a model that outputs values in a certain range.)

Emphasizing the service option causes the customer's attention to tend to be drawn to the service option within the graphical user interface provided by the online concierge system 140, relative to other service options. For example, emphasis may be provided to a service option by highlighting or otherwise visually emphasizing the service option within the portion of the user interface that a representation of the service option already occupies (e.g., a button representing the service option). Emphasis may also be provided by adding additional material to the user interface referring to the service option, such as adding a banner describing the service option (e.g., “Did you know?: Priority delivery will reduce delivery time by an estimated 72 minutes”). Alternatively and/or additionally, the various service options may be ranked according to prediction of favorability, showing higher-ranked service options “higher” (more prominently) within the user interface, and service options with predictions of favorability below a particular threshold may be omitted from the user interface.

In addition to using the option suggestion module 315 to selectively emphasize particular service options, in some embodiments the options personalization module 250 uses the location metrics 304 in other ways to provide customers with insights. For example, in some embodiments, the options personalization module 250 shows retailer location metrics—such as wait times, crowdedness, parking availability, and other measures related to the experience of visiting the retailer in person—to the customer when the customer is formulating an order to be fulfilled at that retailer. Such information aids customers in determining whether to pick up the items themselves at the retailer location, or whether to opt for delivery of the items to their residences. As some specific examples, the retailer location metrics can be shown organically within a user interface (e.g., when the user interface is allowing the customer to choose between self-pick-up and delivery, the user interface can display a line length metric to the customer so that the customer can assess how long the self-pick-up might take at the retailer location in question), or pushed to the customer at certain times (e.g., during popular delivery times) for the customer's most-frequented stores, or used when the user is selecting a particular service option to warn the user if the selection of that service option is likely to lead to a poor experience, and to offer a different service option that is expected to provide a better experience.

In some embodiments, the options personalization module 250 can use the location metrics 304 to estimate values such as delivery cost and provide alternatives, such as providing an option to have a later delivery at a reduced cost. The organization in charge of the online concierge system 140 may also consider the location metrics 304 as part of analyses such as at which retailers to offer service, what prices are appropriate, and the like.

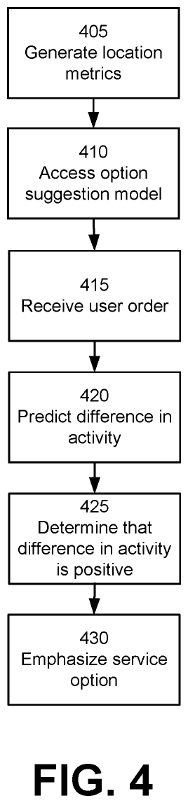

FIG. 4 illustrates steps performed by the options personalization module 250 when determining whether to emphasize a particular service option to a user, according to some embodiments.

As part of preprocessing, the options personalization module 250 generates 405 location metrics, as discussed above with respect to the metrics derivation module 305 and the location metrics 304. The options personalization module 250 additionally accesses 410 a previously-trained option suggestion model (e.g., the option suggestion model 306). The online concierge system 140 receives 415 an order from a customer, such as after the customer has specified a set of items to be purchased, but before the customer has finalized fulfillment options and payment. The order includes the associated set of items to be acquired from a particular retailer. In order to determine whether to emphasize one or more service options (e.g., delivery speed options) to the customer when the customer is specifying options for completing the order, the options personalization module 250 uses the option suggestion model to predict 420 a difference in activity of the customer due to emphasizing the first service option to the customer (e.g., that the customer will likely purchase fewer items over the next two weeks if the priority delivery option is not emphasized). The options personalization module 250 determines 425 that the predicted difference in activity is positive, in that emphasizing the service option produces a more favorable outcome than not emphasizing it. Accordingly, the options personalization module 250 emphasizes 430 the service option to the customer (e.g., by displaying a visual highlight around an indicator of the service option in a user interface provided to the customer).

Alternative embodiments may include more, fewer, or different steps from those illustrated in FIG. 4, and the steps may be performed in a different order from that illustrated in FIG. 4. Additionally, each of these steps may be performed automatically by the online concierge system 140 without human intervention.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method performed at a computer system comprising a processor and a computer-readable medium, the method comprising:
generating location features from entries of a log associating times, locations, and actions;
accessing a machine-learned option suggestion model that inputs location features for an order of a user and outputs a predicted difference in activity of the user due to emphasizing a first service option to the user;
receiving a request to create an order of a first user for items from a first retailer;
identifying location features corresponding to the order within the generated location features;
inputting the identified location features to the machine-learned option suggestion model to predict a difference in activity of the first user due to emphasizing the first service option to the first user;
determining that the predicted difference in activity of the first user is positive; and
responsive to determining that the predicted difference in activity of the first user is positive, sending, to a client device of the user, a signal to cause the client device to emphasize the first service option to the first user in a user interface on the client device.

2. The method of claim 1, wherein generating the location features comprises generating user residence features including at least one of: time to deliver an item from a store to a residence of a user, time to find a parking location for the residence of the user, time to carry the item from the parking location to the residence of the user, or a number of unsuccessful delivery attempts to a neighborhood of the residence of the user.

3. The method of claim 1, wherein generating the location features comprises generating store features including at least one of: time to find parking at a first store, time from parking to entering the first store, time from parking to picking a first item, or a degree of crowdedness of the first store.

4. The method of claim 1, wherein generating the location features comprise generating a time for deliveries from a first store to a user residence.

5. The method of claim 1, further comprising:
identifying location features for prior orders;
determining degrees of the activity of users associated with the prior orders;
determining indications of whether the first service option was emphasized as part of the prior orders; and
training the machine-learned option suggestion model by providing the location features the degrees of activity, and the indications of whether the first service option was emphasized, to a machine learning algorithm.

6. The method of claim 5, wherein providing the location features, the degrees of activity, and the indications to the machine learning algorithm comprises providing the location features, the degrees of activity, and the indications to a meta-learner for uplift modeling.

7. The method of claim 1, further comprising causing modification of the user interface to visually emphasize the first service option.

8. The method of claim 1, wherein determining that the predicted difference in activity of the first user is positive comprises comparing the predicted difference in activity to a threshold value

9. The method of claim 1, further comprising:
displaying one or more of the location features to the user within a user interface.

10. The method of claim 1, further comprising:
using the location features to estimate a delivery cost of the items.

11. A computer-readable storage medium storing instructions that when executed by a computer processor perform actions comprising:
generating location features from entries of a log associating times, locations, and actions;
accessing a machine-learned option suggestion model that inputs location features for an order of a user and outputs a predicted difference in activity of the user due to emphasizing a first service option to the user;
receiving a request to create an order of a first user for items from a first retailer;
identifying location features corresponding to the order within the generated location features;
inputting the identified location features to the machine-learned option suggestion model to predict a difference in activity of the first user due to emphasizing the first service option to the first user;
determining that the predicted difference in activity of the first user is positive; and
responsive to determining that the predicted difference in activity of the first user is positive, sending, to a client device of the user, a signal to cause the client device to emphasize the first service option to the first user in a user interface on the client device.

12. The computer-readable storage medium of claim 11, wherein generating the location features comprises generating user residence features including at least one of: time to deliver an item from a store to a residence of a user, time to find a parking location for the residence of the user, time to carry the item from the parking location to the residence of the user, or a number of unsuccessful delivery attempts to a neighborhood of the residence of the user.

13. The computer-readable storage medium of claim 11, wherein generating the location features comprises generating store features including at least one of: time to find parking at a first store, time from parking to entering the first store, time from parking to picking a first item, or a degree of crowdedness of the first store.

14. The computer-readable storage medium of claim 11, wherein generating the location features comprises generating time for deliveries from a first store to a user residence.

15. The computer-readable storage medium of claim 11, the actions further comprising:
identifying location features for prior orders;
determining degrees of the activity of users associated with the prior orders;
determining indications of whether the first service option was emphasized as part of the prior orders; and
training the machine-learned option suggestion model by providing the location features the degrees of activity, and the indications of whether the first service option was emphasized, to a machine learning algorithm.

16. The computer-readable storage medium of claim 15, wherein providing the location features, the degrees of activity, and the indications to the machine learning algorithm comprises providing the location features, the degrees of activity, and the indications to a meta-learner for uplift modeling.

17. The computer-readable storage medium of claim 11, the actions further comprising causing modification of the user interface to visually emphasize the first service option.

18. The computer-readable storage medium of claim 11, wherein determining that the predicted difference in activity of the first user is positive comprises comparing the predicted difference in activity to a threshold value.

19. The computer-readable storage medium of claim 11, the actions further comprising displaying one or more of the location features to the user within a user interface.

20. A computer system comprising:
a computer processor; and
a computer-readable storage medium storing instructions that when executed by a computer processor perform actions comprising:
generating location features from entries of a log associating times, locations, and actions;
accessing a machine-learned option suggestion model that inputs location features for an order of a user and outputs a predicted difference in activity of the user due to emphasizing a first service option to the user;
receiving a request to create an order of a first user for items from a first retailer;
identifying location features corresponding to the order within the generated location features;
inputting the identified location features to the machine-learned option suggestion model to predict a difference in activity of the first user due to emphasizing the first service option to the first user;
determining that the predicted difference in activity of the first user is positive; and
responsive to determining that the predicted difference in activity of the first user is positive, sending, to a client device of the user, a signal to cause the client device to emphasize the first service option to the first user in a user interface on the client device.
